(19) United States
(12) Patent Application Publication
(10) Pub. No.: US 2014/0112746 A1
(43) Pub. Date: Apr. 24, 2014

(54) METHOD AND APPARATUS FOR AUTOMATICALLY VISUALLY POSITIONING TRAIN CAR BEDS

(71) Applicant: MORGAN ENGINEERING SYSTEMS, INC., Alliance, OH (US)

(72) Inventors: Mark Len Fedor, Hartville, OH (US); Mark Thomas Sharamitaro, Uniontown, OH (US); John Junior Kost, Oshawa (CA); Philip Anthony West, Scarborough (CA)

(73) Assignee: MORGAN ENGINEERING SYSTEMS, INC., Alliance, OH (US)

(21) Appl. No.: 13/658,938

(22) Filed: Oct. 24, 2012

(51) Int. Cl. B65G 67/04

(52) U.S. Cl. 414/390; 414/809

(57) ABSTRACT

A system and method for automatically positioning a metal coil into a rail car using stereoscopic image processing is presented. A method begins by picking up the metal coil using a hoist of a crane. The metal coil is then moved to a position over a rail car to where the metal coil will be located. At least one stereoscopic photo is taken of a location in the rail car to where the metal coil will be located. The coil is accurately positioned as it is lowered based on data extracted from the stereoscopic photo(s) to determine where the coil is as it is lowered onto the rail car. The picking up the metal coil, the moving the metal coil to a position over a rail car and the lowering the metal coil into the rail car are performed automatically without human involvement.

### BACKGROUND OF THE INVENTION

1. Field of Invention

The current invention relates generally to apparatus, systems and methods for loading steels coils onto trains. More particularly, the apparatus, systems and methods relate to automatically loading steels coils onto trains. Specifically, the apparatus, systems and methods provide for automatically loading steels coils onto rail cars using images from stereo cameras to position and guide the steel coils onto the rail cars.

2. Description of Related Art

In metalworking, rolling is a metal forming process in which metal stock is passed through a pair of rolls. Rolling is classified according to the temperature of the metal rolled. If the temperature of the metal is above its recrystallization temperature then the process is termed as hot rolling. If the temperature of the metal is below its recrystallization temperature the process is termed as cold rolling. In terms of usage, hot rolling processes more tonnage than any other manufacturing process and cold rolling processes the most tonnage out of all cold working processes.

When the steel passes through its final set of rollers it is then coiled into a cylindrically-shaped coil. Coils of rolled steel can be very heavy weighing tens of thousands of pounds and can be awkward to maneuver and transport. When steel coils are produced, they are often first moved to a cooling area knows as a coil yard. Later, they may be moved again for loading onto a rail car for transportation by train. Because the coils are so heavy, special overhead cranes are often used to move the steel coils to load them onto rail cars. Often these cranes are controlled by a person holding a control device used to control the movement and functionality of the crane. While holding the control device, that person would follow the crane moving a steel coil and that movement may require him to walk on surfaces near the steel coil being moved as well as on catwalks, up stairs and down stairs. Often, this person is looking overhead which can cause them to fall off catwalks, down stairs and/or lose their attention to cause life threatening movement of the crane and the steel coil it is moving. Therefore, a better way of moving coils in a coil yard is desired.

### A BRIEF SUMMARY OF THE INVENTION

The preferred embodiment of the invention includes a method for automatically positioning a metal coil into rail cars using stereoscopic images. The method begins by picking up the metal coil using a hoist of a crane. The metal coil is then moved to a position over a rail car to where the metal coil will be located. At least one stereoscopic photo is taken of a location in the rail car to where the metal coil will be located. The coil is accurately positioned as it is lowered based on data extracted from the stereoscopic photo(s) to determine a “determined position” of where the coil is as it is lowered onto the rail car. The picking up of the metal coil, the moving of the metal coil to a position over a rail car and the lowering of the metal coil into the rail car are performed automatically without human involvement.

In another configuration, the method can include comparing the stereoscopic photo to a predetermined image of a location in a rail car to where the metal coil will be located. This comparison can be used to further refine how to position the metal coil as it is placed onto the rail car. The comparison of the stereoscopic photo to the predetermined image of the location in the rail car where the metal coil will be located can be based, at least in part, on the rail car type. In some implementations, the predetermined image can be selected based on the rail car type.

Other configurations can include taking a stereographic photo of two different locations using two different stereoscopic cameras. This can include taking a first stereographic photo adjacent a first side of the metal coil and taking a second stereographic photo adjacent a second side of the metal coil. These two images can be used in determining the determined position of the metal coil. Lighting can be used to light up both sides of the coil prior to taking the stereographic photos.

The method can also include other useful actions used to more accurately pick up and place a metal coil. For example, the method can also include taking stereoscopy photos of a saddle of the location in the rail car to where the metal coil will be located. Additionally, the method can use a laser positioning system to determine a position of the crane. The method can determine where to pick up a coil by first finding a central opening from stereoscopic photos. Hoist tongs can then more accurately be inserted into that opening.

Another configuration of the preferred embodiment is a system for automatically positioning a metal coil into a rail car. The system includes a crane with a hoist for lifting a metal coil and for lowering the metal coil onto the rail car. The crane includes a hoist with a hoist frame. A stereoscopic camera is mounted on the hoist frame. The stereoscopic camera takes a stereoscopic image of a location on the rail car to where the metal coil is to be placed. Stereoscopic image processing logic processes the stereoscopic image to determine a position of the metal coil relative to the location on the rail car based, at least in part, on the stereoscopic image. The crane and the stereoscopic image processing logic can work together to pick up the metal coil and place the metal coil onto the rail car automatically and without human intervention.

The system can further include a second stereoscopic camera on a corner of the hoist frame configured to take stereoscopic images of a second side of the location on the rail car to where the metal coil is to be placed. The first stereoscopic camera is on a corner of the hoist frame diagonal to the second stereoscopic camera and the first stereoscopic camera takes stereoscopic images of a first side of the location on the rail car to where the metal coil is to be placed. Two lights are located on corners of the hoist frame between the first stereoscopic camera and the second stereoscopic camera and can be used to illuminate the rail car.

The system for automatically positioning a metal coil into a rail can further include memory storing a pre-stored image of the location on the rail car to where the metal coil is to be placed. The stereoscopic image processing logic can use that pre-stored image to determine the position of the metal coil relative to the location on the rail where the coil is to be placed by comparing stereoscopic images of the rail car to the pre-stored image.

### BRIEF DESCRIPTION OF SEVERAL VIEWS OF THE DRAWINGS

One or more preferred embodiments that illustrate the best mode(s) are set forth in the drawings and in the following description. The appended claims particularly and distinctly point out and set forth the invention.

The accompanying drawings, which are incorporated in and constitute a part of the specification, illustrate various example methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 illustrates a typical coil yard where metal coils are placed after they are produced so that they can cool before they are loaded onto rail cars for transportation.

FIG. 2 illustrates the preferred embodiment of a crane and a hoist with a stereoscopic imaging system used to accurately lift and then place metal coils onto rail cars.

FIG. 3 illustrates further details of an example crane and hoist combination used to move metal coils within a coil yard.

FIG. 4 illustrates an example stereoscopic image processing system for automatically controlling the crane to locate, pick-up and load metal coils onto rail cars.

FIGS. 5A-5B illustrate an embodiment of a method for using a stereoscopic image processing system for automatically controlling the crane to locate, pick-up and load metal coils onto rail cars.

FIG. 6 illustrates an example view of three rail cars and positions for loading metal coils onto the rail cars.

Similar numbers refer to similar parts throughout the drawings.

### DETAILED DESCRIPTION

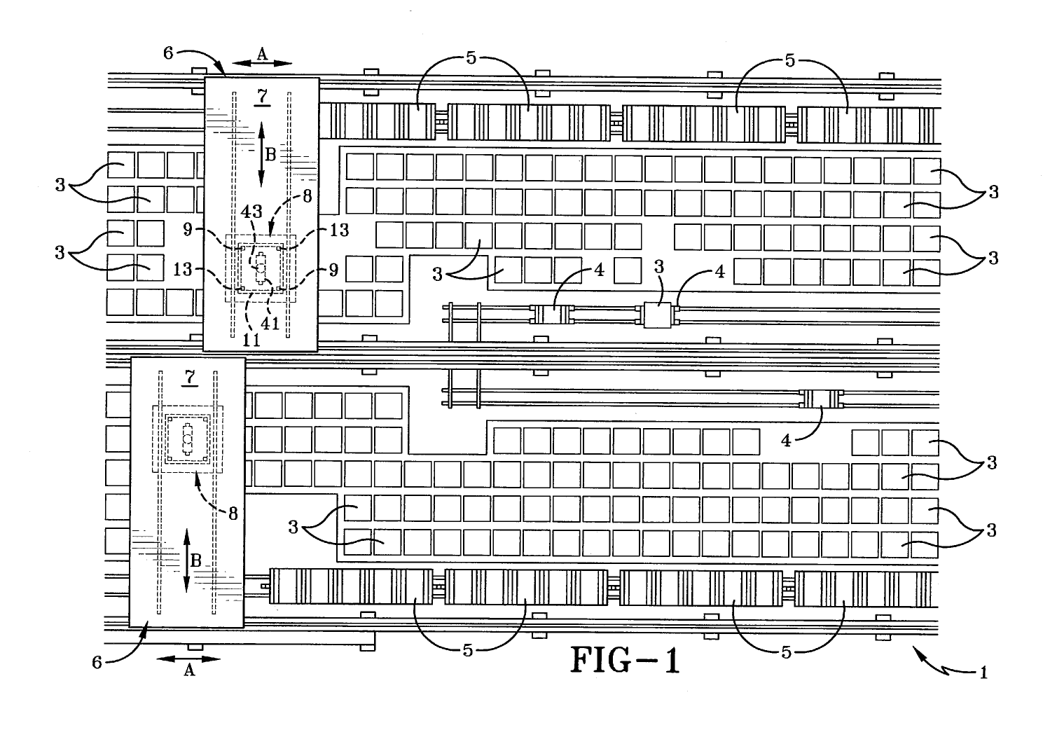

FIG. 1 illustrates an example coil yard 1 in which the preferred embodiment of the invention operates. The illustrated coil yard 1 is an indoor coil yard where rolled metal coils 3 are stored after they have been manufactured and are awaiting transport by rail cars 5. The coil yard 1 is illustrated with four rail cars 5 in an upper portion of the coil yard and four rail cars 5 in a lower portion of the coil yard 1. Three shuttle cars 4 are shown near the middle of the figure. The shuttle cars 4 are configured to bring recently produce rolled coils 3 into the coil yard for cooling. As illustrated in this figure, the cranes 6 have unloaded two of the three shuttle cars 4 and one shuttle car 4 still needs to have its coil 3 unload. In some configurations, the shuttle cars 4 can include global positioning systems (GPSs). The GPS devices can be used to accurately locate where each shuttle car 4 is located so that the cranes know where a shuttle car is located so that it can be unloaded as discussed in greater detail below.

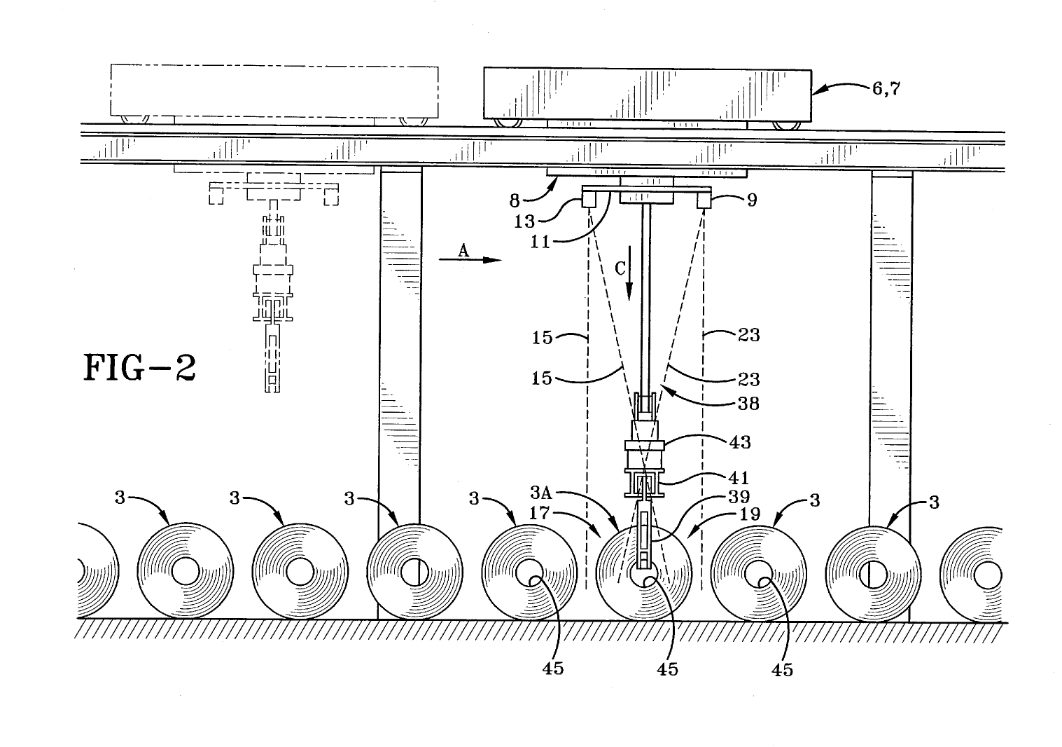

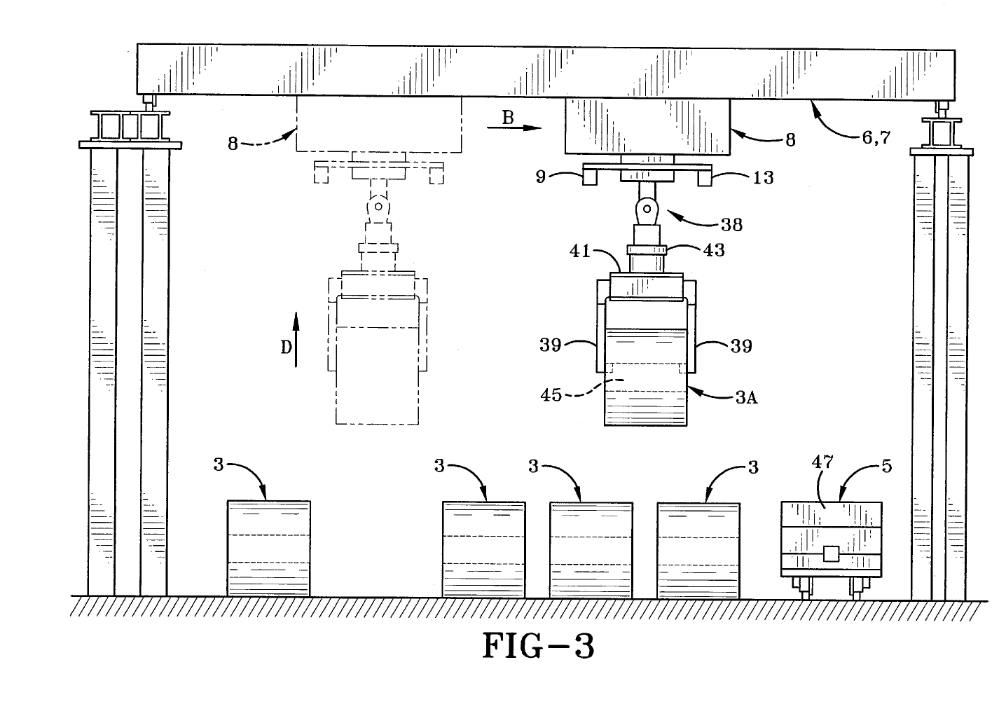

Because the steel coils 3 can be very heavy, custom cranes are often used to pick them up from the coil yard 1 and load them onto a rail car 5. FIGS. 2 and 3 illustrate an example crane 6 that is used to lift steel coils 3 and place them on a rail car 5. Each crane 6 includes an upper portion 7 and a lower portion 8. The upper portion allows a crane 6 to move a crane hoist 38 (discussed later) in the direction of arrow A (FIGS. 1 and 2) and the lower portion provides the ability to move the hoist 38 in the direction of arrow B (FIGS. 1 and 3).

A pair of stereoscopic cameras 9 are mounted on two corners of a frame 11 mounted to the bottom side of the crane 6. The two cameras 9 can be best seen together in the top view of FIG. 1. In the preferred embodiment, the stereoscopic cameras 9 need to have the ability to operate in the high temperatures of the coil yard 1 so the cameras 9 should be able to operate up to about 70° C. Two lights 13 are attached to adjacent corners of the frame 11 to provide light for two views captured by each stereoscopic camera 9. The two cameras 9 and the two lights 13 are best seen in relation to one another from the top view of the yard 1 in FIG. 1. As shown in FIGS. 2 and 3, dashed lines 15 show how the lights 13 light up the left side 17 and the right side 19 of particular coil 3A that the crane 6 is to hoist. The two stereoscopic cameras 9 are mounted so that they can capture images of both the left side 17 and the right side 19 of coil 3A with the focal area as illustrated by dashed lines 23.

In the preferred embodiment and for the purpose of simplicity, the Figures illustrate a pair of stereoscopic cameras and the Specification discusses a pair of stereoscopic cameras. However, those of ordinary skill in the art can appreciate that in other embodiments of the invention more stereoscopic cameras can be used or only a single stereoscopic camera can be used. Of course, the number of stereoscopic cameras and lighting fixtures can be different and they do not have to be used in equal numbers as illustrated and described in the present Specification. When using multiple stereoscopic cameras, multiple different images may be captured to produce more accurate special images. Likewise, adaptive lighting can be used in different environments and positions that the cameras operate in order to enhance stereoscopic images in ever changing conditions. It is even conceivable that any number of stereoscopic cameras, non-stereoscopic cameras, lighting systems, adaptive lighting systems and the like can be used to implement different embodiments of novel features of this invention.

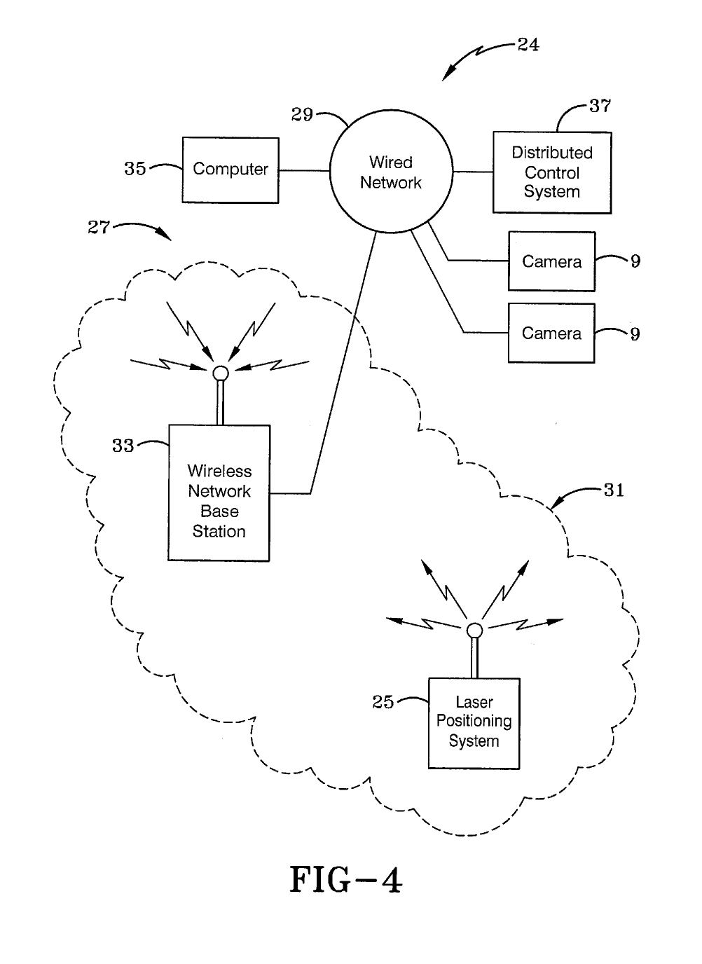

FIG. 4 illustrates some components of a stereoscopic image processing system 24 for automatically controlling the crane 6 to locate, pickup and load coils 3 onto rail cars 5. System 24 includes a laser positioning system 25 configured to determine the location of the crane. One or more of the crane 6, cameras 9 and laser positioning system 25 can be connected to a communication network 27 that can be any configuration as understood by those of ordinary skill in that art. The network 27 can include wired networks 29 and/or wireless networks 31 set up by one or more wireless base stations 33 or other wireless devices. Additionally, one or more of the crane 6, cameras 9 and laser positioning system 25 can be configured to interact over the network 27 in coordination with a computer 35, a distributed control system (DCS) 37, another electronic logic and/or other electronic devices to determine the positioning of steel coils, saddles in the rail cars 5 and/or other objects as describe further below. For example, the computer 35 can be running video image processing software and algorithms that process images captured by the stereo cameras 9 and determine the position of a crane 6 relative to a steel coil 3A or the saddle of a rail car 5. The DCS can be a traditional Siemens control system such as the SIMATIC PCS 7 or another type of DCS as understood by those of ordinary skill in the art.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

As mentioned above, the crane 6 further includes a hoist 38. The hoist 38 includes coil tongs 39, a tong support structure 41 and a rotation package 43. The rotation package 43 is attached to the crane 6 and has a motor for rotating the tong support structure 41 and the pair of coil tongs 39. The tong support structure 41 supports the coil tongs 39 and is configured to move the coil tongs 39 into and out of engagement with steel coils 3.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

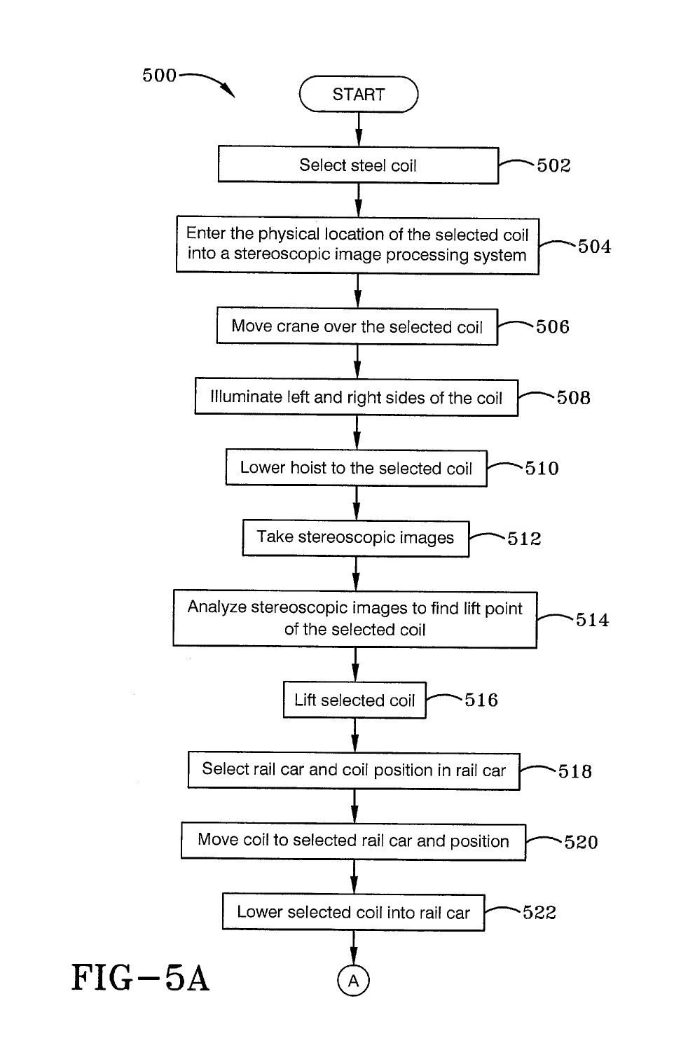

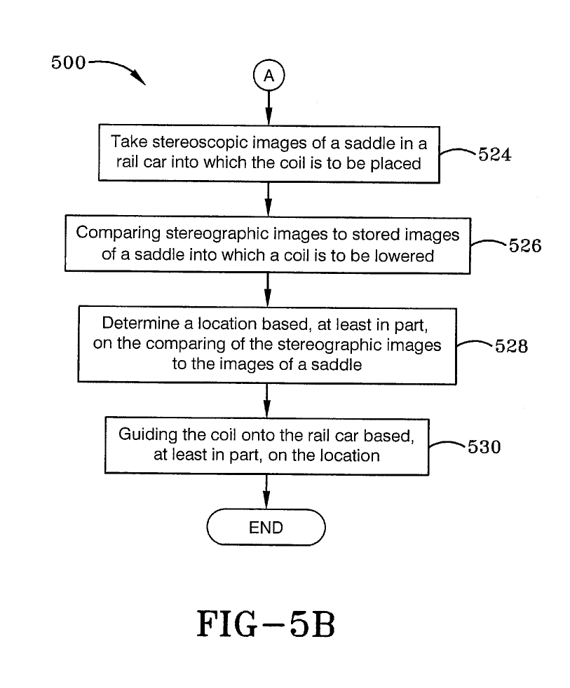

FIG. 5 illustrates a method 500 of using one or more pairs of stereoscopic cameras to place steel coils into a rail car. The method 500 begins by selecting a steel coil in a coil yard, at 502, as a selected steel coil 3A for loading onto a rail car 5. In the past, the selected steel coil 3A can then be lifted from the coil yard by manually positioning the crane 6 and hoist 38 over the coil and then manually controlling the hoist to lift the coil 3A. As discussed earlier, this is a hot and dangerous environment so the preferred embodiment of this invention automates this process. In one example embodiment of the preferred embodiment, the method 500 begins by entering data representing a location of the selected steel 3A coil in the coil yard 1, at 504, into the stereoscopic image processing system 24 of FIG. 4.

After the selected coil 3A and its location is known, the method 500 then moves the crane 6 and hoist 38 over the selected coil 3A, at 506. The method 500 can use the stereoscopic image processing system 24 to move the crane 6 and its hoist 38 over the coil 3A. After it is over the coil 3A, the left 17 and right 19 sides of the selected coil 3A can be illuminated, at 508. This allows better stereoscopic images to be taken of the coil 3A. In addition to using stereoscopic imaging, the alternative method 500 can use GPS devices to communicate the location of a shuttle car 4 to the crane 6 and the crane 6 can use this information to move the crane 6 over that particular shuttle car 4. The method 500 can now begin lowering the hoist 38 down in the direction of arrow C in FIG. 2 to the coil, at 510.

Just before and/or while lowering the hoist 38 to the coil the method 500 can begin taking stereoscopic images, at 512, of the left side 17 and right side 19 of the selected coil 3A. In the preferred embodiment, one stereoscopic camera takes pictures of the left side 17 of the coil 3A and a second stereoscopic camera takes pictures of the right side 19 of the coil 3A. A series of stereoscopic images can be taken as the tong support structure 41 and coil tongs 39 are lowered. When the lights 11 and cameras 9 are properly positioned, there while be no light glare so that an image taken of the opening 45 can be processed to determine the bottom surface just inside the opening 45. Once the bottom surface of the opening 45 is determined, these images are analyzed to find the central opening (e.g., eye) 45 of the steel coil, at 514. For example, the stereo images can be analyzed with image analysis software and algorithms running on the computer 35 in the stereoscopic image processing system 24 of FIG. 4. Other ways of analyzing the stereoscopic images can be used as understood by one of ordinary skill in this art.

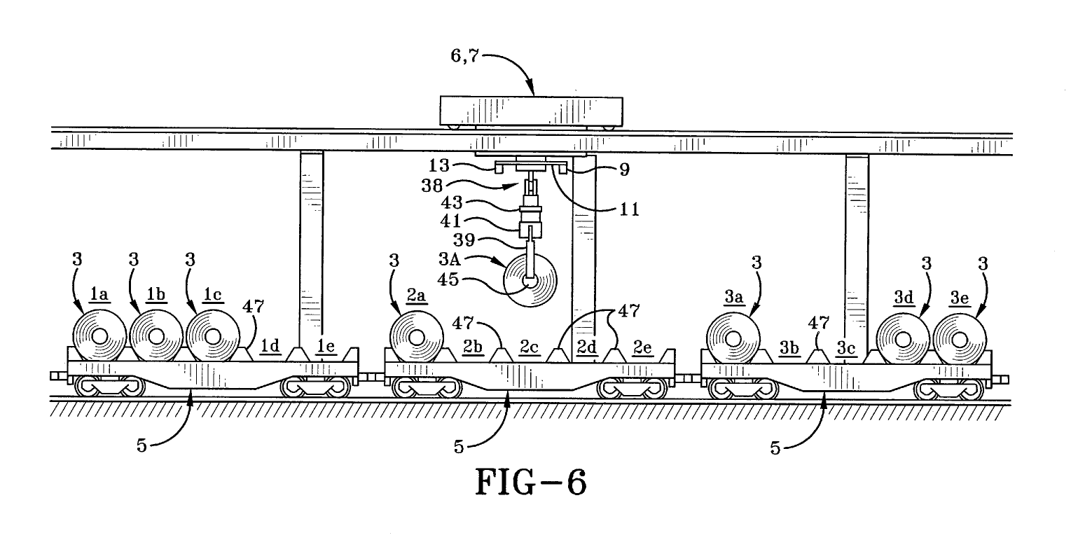

Once the central opening 45 has been found, the hoist 38 is lowered and centered above the selected coil 3A so that pairs of lower arms of the coil tongs 39 can be slid into the central opening 45. The coil 3A is lifted in the direction of arrow D in FIG. 3, at 516, in preparation for transportation to a rail car 5. A rail car 5 and a position in the rail car are selected, at 518, for where the selected coil 3A is to be placed. FIG. 6 illustrates 3 rail cars 5 that can each hold five steel coils. For example, the third position of the second rail car 5 (position “2c”) can be selected for the destination of the selected coil. The selected coil 3A is then automatically moved overhead by the stereoscopic image processing system 24 to that location, at 520, by the crane 6 above the selected position “2c” in the second rail car 5. The method 500 lowers the selected coil 3A downward and into the rail car, at 522. In some configurations of the preferred embodiment, a laser positioning system 25 (FIG. 4) can be used to assist the crane 6 in moving the coil into position and/or lowering the coil into the rail car.

As the coil 3A is lowered, the method 500 again can begin taking stereoscopic images, at 524. This time, images are taken of the left side and right side of saddles 47 forming a position in the rail car 5 into which the selected coil 3A is being lowered. In the preferred embodiment, one stereoscopic camera 9 takes pictures of the left side of a saddle 47 into which the coil is being lowered and a second stereoscopic camera 9 takes pictures of the right side of a saddle 47 into which the coil is being lowered. In general, five or so different types of rail cars currently exist so once the rail car type is known, its type of saddle used to hold coils loaded into that rail car can be determined. Some rails cars have beam structures used to hold coils and in those cases the beam structures can be determined.

Once the saddle type is determined, a predefined image of that saddle type can be extracted. The method 500 then compares stereograph images to the extracted saddle type, at 526, as the coil 3A is lowered by the hoist 38 toward the selected rail car position “2c”. The comparisons can be used to calculate and generate a precise position of the coil, at 528, relative to the selected rail car position. Any suitable software, imaging processing algorithm or other logic as understood by those of ordinary skill in the art can be used in determining the position of the coil relative to the selected rail car position. In some configurations, the laser positioning system 25 can also be used to determine the position of the coil. The method 500 can use this location to automatically adjust how the coil 3A is lowered and guided into position “2c” in the rail car 5.

In some configurations, the method 500 can determine the location of the coil and/or saddles by first determining the physical location of the cameras. This physical location is then translated into X, Y and/or Z dimensions. For example, the expected location where the coil is to be located in a rail car may be (142′, 42′). However, as the coil is lowered, based on the stereographic images and location/position calculations, it may be determined that the X value is really 0.7° larger and the Y value is really 0.5° larger. In this case, the (X, Y) value can be updated to (142.7′, 42.5°) for subsequent uses.

In the foregoing description, certain terms have been used for brevity, clearness, and understanding. No unnecessary limitations are to be implied therefrom beyond the requirement of the prior art because such terms are used for descriptive purposes and are intended to be broadly construed. Therefore, the invention is not limited to the specific details, the representative embodiments, and illustrative examples shown and described. Thus, this application is intended to embrace alterations, modifications, and variations that fall within the scope of the appended claims.

Moreover, the description and illustration of the invention is an example and the invention is not limited to the exact details shown or described. References to “the preferred embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in the preferred embodiment” does not necessarily refer to the same embodiment, though it may.

What is claimed is:

1. A method for automatically positioning a metal coil into a rail car using stereoscopic image processing comprising:
picking up the metal coil using a hoist of a crane;
moving the metal coil to a position over a rail car to where the metal coil will be located;
taking a stereoscopic photo of a location in the rail car to where the metal coil will be located;
determining a determined position of the metal coil based, at least in part, on the stereoscopic photo; and
lowering the metal coil into the rail car based, at least in part, on the determined position, wherein the picking up of the metal coil, the moving of the metal coil to a position over a rail car and the lowering of the metal coil into the rail car are performed automatically without human involvement.

2. The method for automatically positioning metal coils into rail cars using stereoscopic image processing of claim 1 further comprising:
comparing the stereoscopic photo to a predetermined image of a location in a rail car to where the metal coil will be located, wherein the determining at least one determined position of the metal coil is based, at least in part, on the comparison.

3. The method for automatically positioning metal coils into rail cars using stereoscopic image processing of claim 2 further comprising:
determining a rail car type of the rail car to where the metal coil will be located, wherein the comparison of the stereoscopic photo to the predetermined image of the location in the rail car to where the metal coil will be located is based, at least in part, on the rail car type.

4. The method for automatically positioning metal coils into rail cars using stereoscopic image processing of claim 3 further comprising:
selecting the predetermined image based on the rail car type.

5. The method for automatically positioning metal coils into rail cars using stereoscopic image processing of claim 1 wherein the taking stereoscopic photo of the location in the rail car to where the metal coil will be located further comprises:
taking a stereographic photo of two different locations using two different stereoscopic cameras.

6. The method for automatically positioning metal coils into rail cars using the stereoscopic image processing of claim 1 wherein the taking a stereoscopic photo of the location in the rail car to where the metal coil will be located further comprises:
taking a first stereographic photo adjacent a first side of the metal coil; and
taking a second stereographic photo adjacent a second side of the metal coil; and wherein the determining at least one determined position of the metal coil is based, at least in part, on the first stereographic photo and the second stereographic photo.

7. The method for automatically positioning metal coils into rail cars using stereoscopic image processing of claim 1 further comprising:
lighting at least one side of the metal coil prior to taking the stereographic photo of the location in the rail car to where the metal coil will be located.

8. The method for automatically positioning metal coils into rail cars using stereoscopic image processing of claim 1 wherein the taking the stereoscopic photo of the location in the rail car to where the metal coil will be located further comprises:
taking stereoscopy photos of a saddle of the location in the rail car to where the metal coil will be located.

9. The method for automatically positioning metal coils into rail cars using stereoscopic image processing of claim 1 further comprising:
using a laser positioning system to determine a position of the crane and, wherein the determining the determined position of the metal coil is based, at least in part, on the position of the crane.

10. The method for automatically positioning metal coils into rail cars using stereoscopic image processing of claim 1 wherein the picking up the metal coil further comprises:
inserting hoist tongs into a central opening of the metal coil.

11. The method for automatically positioning metal coils into rail cars using stereoscopic image processing of claim 10 wherein further comprising:
determining the central opening from the stereoscopic photo.

12. The method for automatically positioning metal coils into rail cars using stereoscopic image processing of claim 1 further comprising:
rotating the metal coil prior to the lowering the metal coil into the rail car.

13. A system for automatically positioning a metal coil into a rail car comprising:
a crane with a hoist for lifting a metal coil and for lowering the metal coil onto the rail car;
a hoist frame;
a stereoscopic camera mounted on the hoist frame, configured to take a stereoscopic image of a location on the rail car to where the metal coil is to be placed;
stereoscopic image processing logic configured to process the stereoscopic image to determine a position of the metal coil relative to the location on the rail car based, at least in part, on the stereoscopic image; and
wherein, the crane and the stereoscopic image processing logic are configured to pick up the metal coil and place the metal coil in the location on the rail car automatically without human intervention.

14. The system for automatically positioning a metal coil into a rail car of claim 13 wherein the stereoscopic camera is a first stereoscopic camera and further comprising:
a second stereoscopic camera on a corner of the hoist frame configured to take stereoscopic images of a second side of the location on the rail car to where the metal coil is to be placed, wherein the first stereoscopic camera is on a corner of the hoist frame diagonal to the second stereoscopic camera and is configured to take stereoscopic images of a first side of the location on the rail car to where the metal coil is to be placed.

15. The system for automatically positioning a metal coil into a rail car of claim 14 further comprising:
two lights on corners of the hoist frame between the first stereoscopic camera and the second stereoscopic camera for illuminating the rail car.

16. The system for automatically positioning a metal coil into a rail car of claim 13 further comprising:
a laser positioning system configured to determine a location of the crane, wherein the stereoscopic image processing logic configured to determine the position of the metal coil based, at least in part, on the location of the crane determined by the laser positioning system.

17. The system for automatically positioning a metal coil into a rail car of claim 13 further comprising:
a memory storing a pre-stored image of the location on the rail car to where the metal coil is to be placed, wherein the stereoscopic image processing logic is configured to determine the position of the metal coil relative to the location on the rail car based, at least in part, on a compare the stereoscopic image with the pre-stored image

18. The system for automatically positioning a metal coil into a rail car of claim 17 wherein the pre-stored image is an image of at least one saddle of a rail car.

19. The system for automatically positioning a metal coil into a rail car of claim 13 further comprising:
a computer, wherein the stereoscopic image processing logic is in the computer; and
a network, wherein the stereoscopic camera communicates with the computer over the network.

20. The system for automatically positioning a metal coil into a rail car of claim 13 wherein the hoist further comprises:
hoist tongs, wherein the stereoscopic image processing logic is configured to process the stereoscopic image to find a central opening of the metal coil, and wherein the hoist is configured to insert and retract the hoist tongs from the central opening.
